(19) United States
(12) Patent Application Publication
(10) Pub. No.: US 2003/0116896 A1
(43) Pub. Date: Jun. 26, 2003

(54) Rotary actuator

(76) Inventors: Christopher M. Obert, Big Rapids, MI (US); Glen R. Wilkinson III, Plainwell, MI (US)

Correspondence Address: PRICE HENEVELD COOPER DEWITT & LITTON, 695 KENMOOR, S.E., P O BOX 2567, GRAND RAPIDS, MI, 49501, US

(21) Appl. No.: 10/152,274

(22) Filed: May 21, 2002

Related U.S. Application Data
(60) Provisional application No. 60/293,460, filed on May 24, 2001.

(51) Int. Cl. F16F 5/00

(52) U.S. Cl. 267/64.12

(57) ABSTRACT

A rotary actuator has a generally cylindrical housing for receiving one end of a control cable having an opposite end coupled to an actuator member of a device to control. Extending within the cylindrical housing is a rotating control handle having a spool which extends into the housing and engages one end of the cable, allowing the cable to wrap around the spool. Engaging an end of the spool within the cylindrical housing in one embodiment is a reversible ratchet disk which is biased against the housing by a compression spring engaging the disk on one side and engaging a locking end cap attached to the housing at the opposite side. The disk can be reversed to provide discrete ratchet stops at incremental positions of the control handle when in a first position or, if reversed, provides continuous reversible movement of the handle.

### CROSS-REFERENCE TO RELATED APPLICATIONS

This application claims priority under 35 U.S.C. § 119(e) on U.S. Provisional Application No. 60/293,460 entitled ROTARY ACTUATOR, filed on May 24, 2001, by Obert et al., the entire disclosure of which is incorporated herein by reference.

### BACKGROUND OF THE INVENTION

The present invention relates to actuators for controlling locking gas cylinders and variable damping rate cylinders utilizing an actuator and more particularly a rotary actuator.

Lever actuators are employed for controlling variable dampers used in, for example, commercial vehicle seats. Locking gas cylinders of the type employed for adjusting the height of office chairs also typically employ levers pivotally mounted to the seat frame and coupled by a cable to a gas cylinder to provide the desired adjustment control of the seat. While such levers are in common use, they do not provide tactile fine adjustment which is sometimes desirable. There exists, therefore, a need for a different type of actuator for use both with locking gas cylinders used in the office chair environment or variable dampers used in commercial vehicle seating. The system and apparatus of the present invention satisfies this need.

### SUMMARY OF THE INVENTION

The present invention provides a rotary actuator comprising a generally cylindrical housing for receiving one end of a control cable having an opposite end coupled to an actuator member of a locking cylinder or damping cylinder. Extending with the cylindrical housing is a rotating control handle having a spool therein which extends within the housing and engages one end of the cable, allowing the cable to wrap around the spool. A control element extends between the spool and housing to selectively hold the handle and spool in a predetermined angular position with respect to the housing. In one embodiment, the control element is a reversible ratchet ring attached to the spool and which is biased against a surface of the housing by a compression spring engaging the ring on one side and engaging a locking end cap attached to the housing at the opposite side. The ratchet ring can be reversed to provide discrete index stops at incremental positions of the control handle when in the first position or, if reversed, provides continuous reversible movement of the handle.

With such assembly, therefore, a single actuator can be manufactured and assembled in two different manners to provide different desired control effects. In either embodiment, a rotary actuator is provided which provides greater tactile control of either a gas locking cylinder or a variable damping rate cylinder.

These and other features, objects and advantages of the present invention will become apparent upon reading the following description thereof together with reference to the accompanying drawings.

### BRIEF DESCRIPTION OF THE DRAWINGS

FIG. 1 is a side elevational view, partly in cross section, of the control system for a locking gas cylinder, showing the control cable coupled thereto;

FIG. 2 is a damping rate cylinder control showing a cable coupled thereto;

FIG. 3 is an exploded perspective view of the rotary actuator of the present invention, shown with a control disk in a first position;

FIG. 4 is an exploded perspective view of the rotary actuator of the present invention showing the control disk in a second position;

FIG. 5 is a top plan view of the rotary actuator;

FIG. 6 is a front elevational view of the rotary actuator;

FIG. 7 is a cross-sectional view taken along section line VII-VII of FIG. 5;

FIG. 8 is an enlarged bottom plan view of a partially assembled actuator, showing the cable connection to a spool of the control handle of the actuator;

FIG. 9 is a vertical cross-sectional view of the handle shown in FIGS. 3-8 taken along section line IX-IX of FIG. 10;

FIG. 10 is a top plan view of the handle shown in FIG. 9;

FIG. 11 is a vertical cross-sectional view of the handle taken along section line XI-XI of FIG. 10;

FIG. 12 is a front elevational view of the handle shown in FIG. 10;

FIG. 13 is a right side view of FIG. 12;

FIG. 14 is a bottom plan view of the handle shown in FIGS. 9-13;

FIG. 15 is an enlarged fragmentary detailed view taken in the direction of arrow XV in FIG. 12;

FIG. 16 is a cross-sectional view taken along section lines XVI-XVI in FIG. 13;

FIG. 17 is a perspective view of the handle shown in FIGS. 9-16;

FIG. 18 is a top plan view of the actuator housing;

FIG. 19 is a side elevational view of the housing shown in FIG. 18;

FIG. 20 is a bottom plan view of the housing;

FIG. 21 is a detailed view of the encircled area XXI in FIG. 19;

FIG. 22 is a right side elevational view of the structure shown in FIG. 19;

FIG. 23 is a cross-sectional view of the housing taken along section lines XXIII-XXIII of FIG. 18;

FIG. 24 is a cross-sectional view taken along section lines XXIV-XXIV of FIG. 18;

FIG. 25 is a detailed view of the encircled area XXV-XXV of FIG. 20;

FIG. 26 is a detailed view of the encircled area XXVI-XXVI of FIG. 22;

FIG. 27 is a top plan view of the actuator ratchet ring shown in FIGS. 3, 4, 7, and 8;

FIG. 28 is a bottom plan view of the ratchet ring shown in FIG. 27;

FIG. 29 is a cross-sectional view taken along section lines XXIX-XXIX of FIG. 26;

FIG. 30 is a detailed view of the encircled area XXX-XXX of FIG. 29;

FIG. 31 is a top plan view of the actuator end cap;

FIG. 32 is a side elevational view of the actuator end cap shown in FIG. 31; and

FIG. 33 is a cross-sectional view taken along section lines XXXIII-XXXIII of FIG. 32.

### DETAILED DESCRIPTION OF THE PREFERRED EMBODIMENT

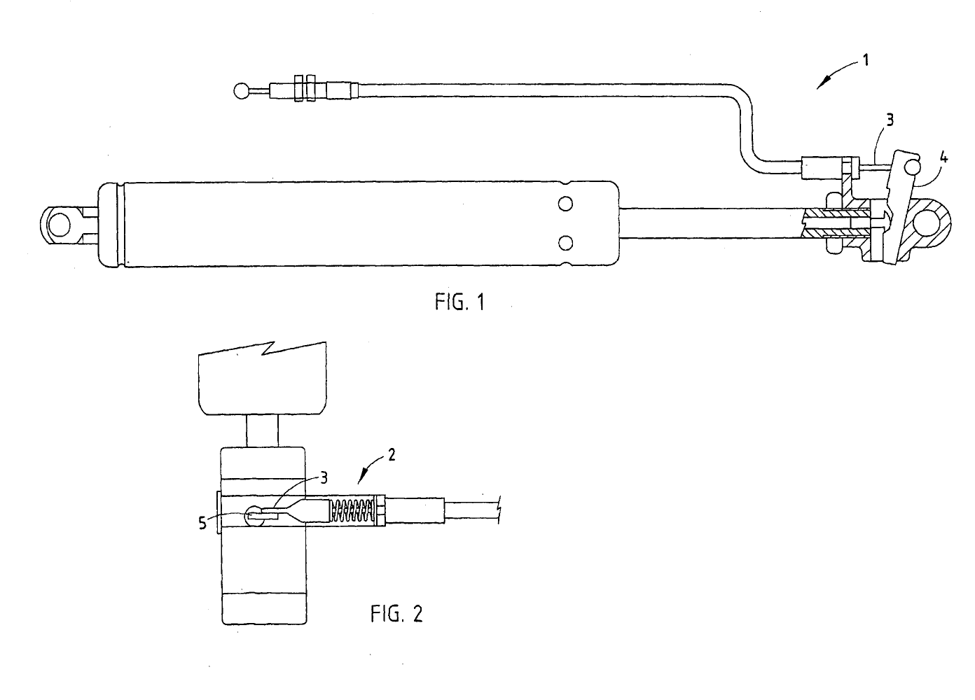

FIGS. 1 and 2 show typical actuator mechanisms for adjustable gas cylinders 1 and adjustable dampers 2, respectively, each of which include a flexible spring biased control cable 3 leading to a control member, such as lever 4 on cylinder 1 or lever 5 on damper 2. The opposite end of each of the cables 3, in the past, has been coupled to a control lever which is mounted to the frame of the seat with which the cylinder or damper is associated. Such levers do not provide an easily selectable finite control of the dampers and cylinders but rather tend to provide only a gross control function, thereby requiring several attempts by the user to adjust the seat to the desired comfort position. The dual rotary actuator of this invention overcomes this problem. Although described in the environment of a seat damper or cylinder control, the actuator of this invention will find application in other areas.

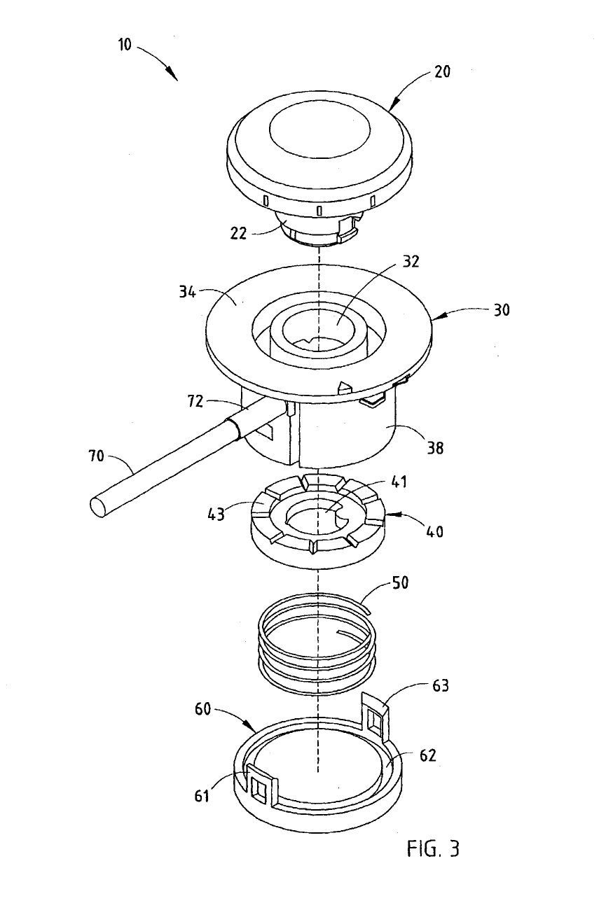

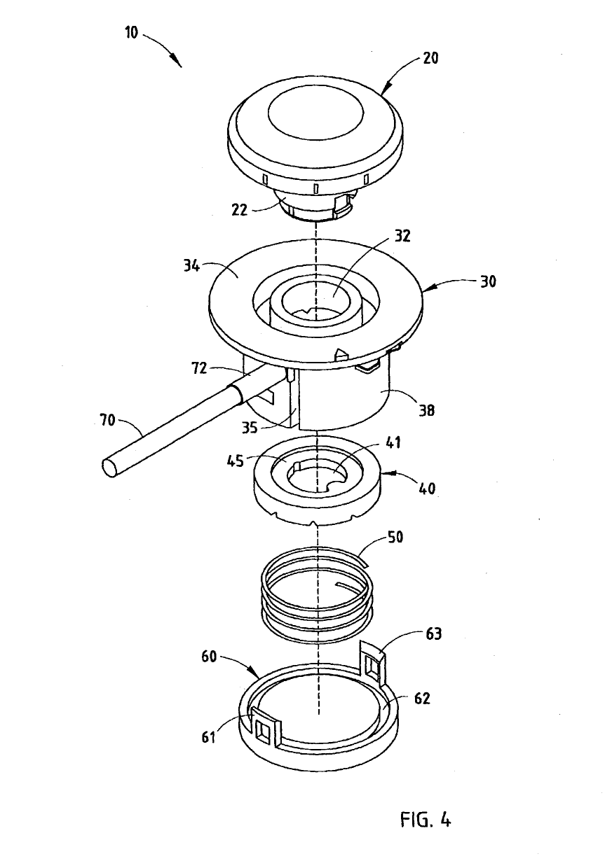

FIGS. 3 and 4 are perspective exploded views of the rotary actuator 10 of the invention which includes a push-down and rotate handle 20 having an integral spool 22 extending downwardly therefrom and fitted into a cylindrical opening 32 of a generally cylindrical housing 30, as seen in FIG. 7. Engaging and snap-locked to the end of spool 22 is a reversible disk-shaped ratchet ring 40 which, in the first position as shown in FIG. 3, includes a plurality of spaced, radially extending slots 43 engaging V-shaped projections 33 (FIGS. 8 and 20) on the mating inner lower annular surface 31 of housing 30. Handle 20, including ratchet ring 40, is urged upwardly with ring 40 in engagement with the projections 33 of housing 30 by means of a compression spring 50 extending between ring 40 and an annular recess 62 in end cap 60. Cap 60 has flexible tangs 61 and 63 which snap-lock the cap to housing 30 by engaging outwardly projecting triangular locking tabs 34 (FIG. 22) on housing 30 to hold actuator 10 together when assembled as seen in FIG. 7.

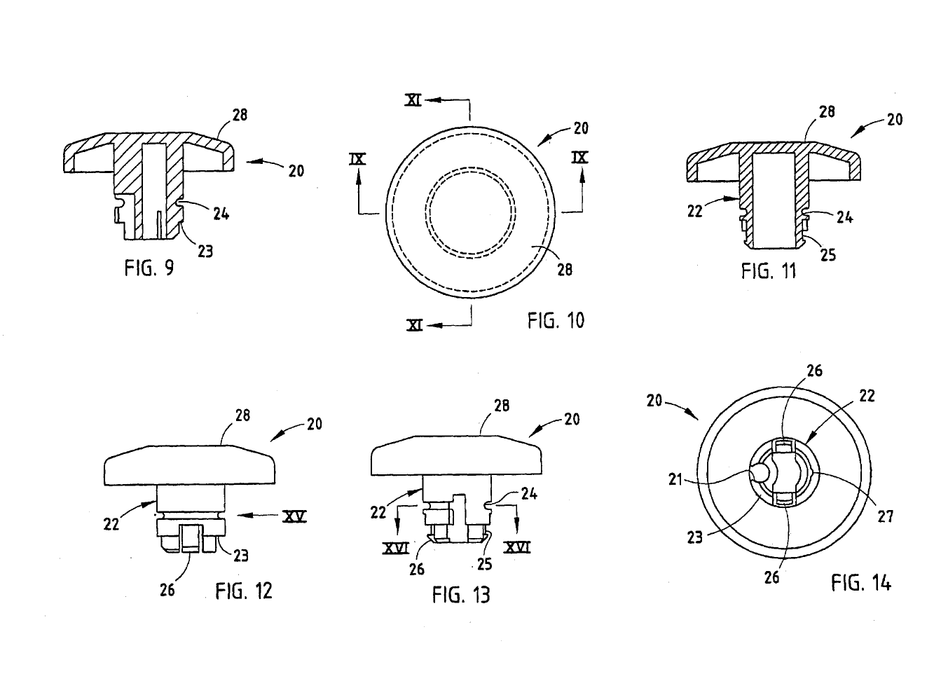

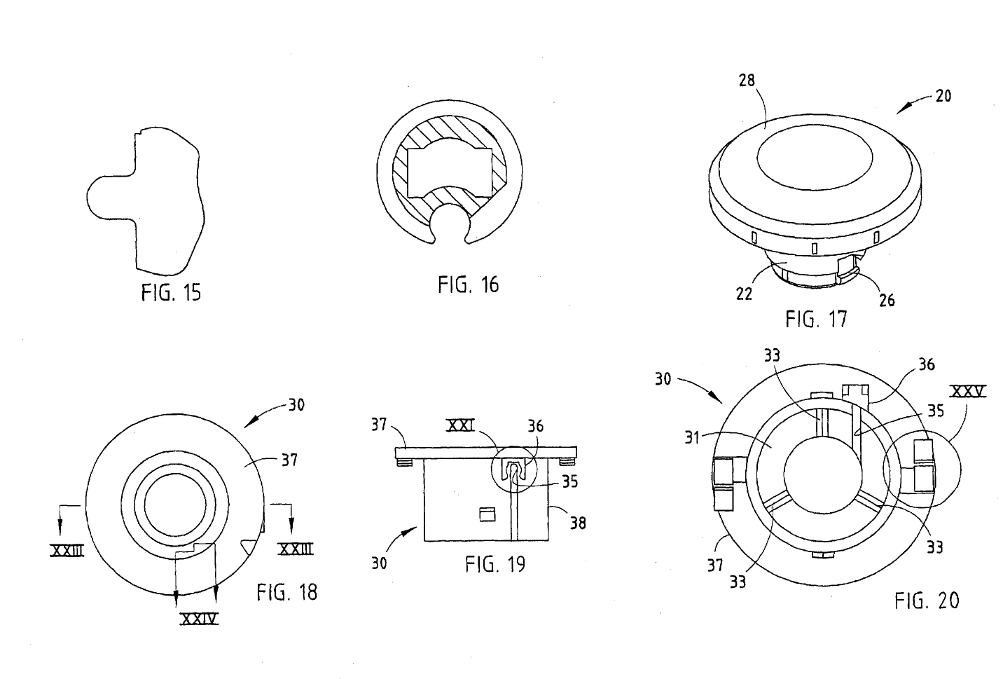

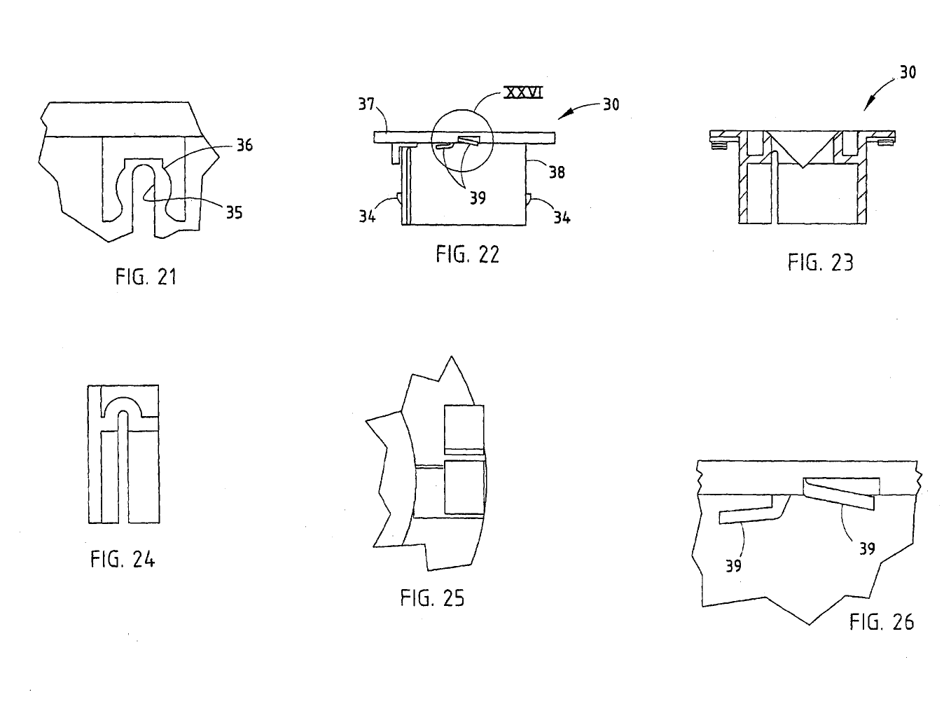

Housing 30 includes slotted opening 35 (FIGS. 1, 19, 20, and 21) with a snap-in collar 36 for receiving the end fitting 72 of control cable 70. Cable 70 has an inner cable 71 (FIGS. 3, 4, and 8) with an anchor lug 73 on one end which fits within a cylindrical recess 21 in the spool 22 of handle 20, as best seen in FIGS. 8 and 14. Spool 22 includes an annular recess 24 (FIGS. 9, 11, and 13) vertically aligned with cable 71 for receiving the cable which wraps around the cylindrical spool 22 as the handle 20 is rotated to extend and/or retract the cable against the bias force of the spring-loaded cylinder (FIGS. 1 and 2) being controlled.

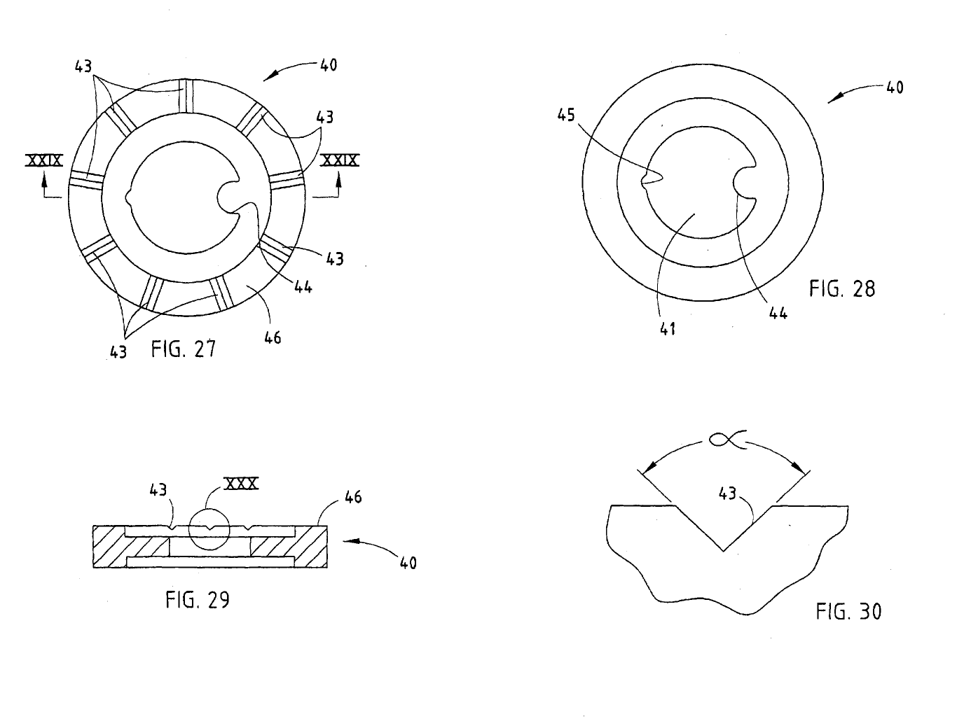

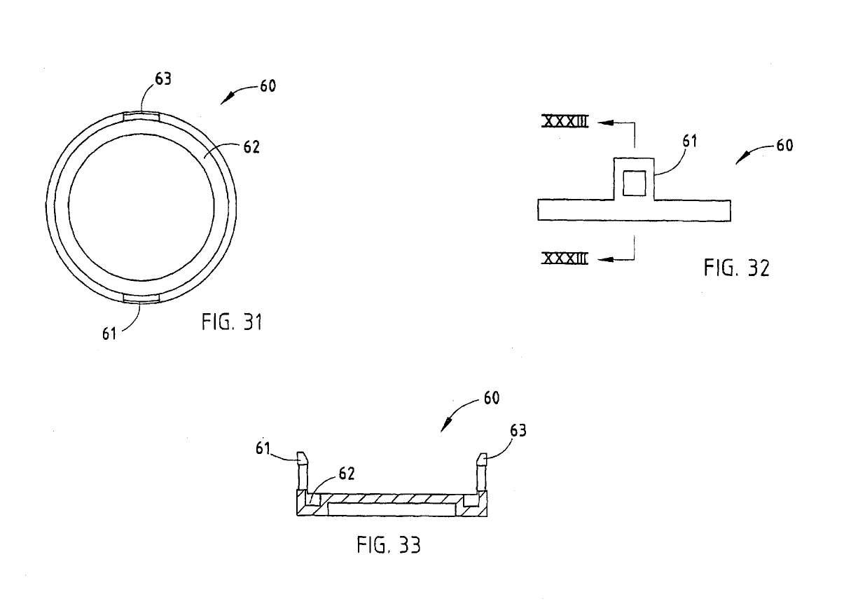

Near the end of handle 20 remote from the integral handle grip 28 (FIGS. 9-12) is an annular shoulder 23 (FIGS. 9 and 14) with associated locking tabs 26 (FIGS. 12-14) for snap-fit receiving and holding the ratchet ring 40 thereon. Shoulder 23 engages a side of ring 40 opposite locking tabs 26 to vertically position the ring 40 on handle 20. The resilient locking tabs 26 (FIGS. 12, 13, and 14) allow the center opening 41 of ratchet ring 40 (FIGS. 27-30) to extend over the lower end of spool 22 and engage and lockably fit within groove 25 in either the first position, shown in FIG. 3, or can be manually pressed inwardly to reverse ring 40 to a reversed second position, shown in FIG. 4. Thus, if desired, the functioning of the actuator can be changed by reversing ring 40. Ring 40 includes a semicylindrical projection 44 (FIGS. 27 and 28) which aligns with aperture 21 in the spool end to cover the lug 73 associated with cable 71 and also index the ring 40 with respect to the handle 20. A second smaller semicylindrical recess 45 is formed in cylindrical central opening 41 of ratchet ring 40 and engages indexing tab 27 (FIG. 14) of spool 22 for alignment during assembly. When extended through slot 35 and when locked to spool 22, inner cable 71 and lug 73, together with ratchet ring 40, engages annular surface 31 (FIGS. 7, 8, and 20) of housing 30 to hold the spring-loaded handle 20 captively within housing 30.

The ratchet ring includes, as best seen in FIGS. 27 and 30, a plurality of spaced notches 43 formed downwardly therein in a V-shape at an angle ∝ of about 86° (FIG. 30) to receive and interengage the 120° spaced projections 33 (FIG. 20) of housing 30. Under the influence of compression spring 50, the ring locks the rotary position of handle 20 in a selected position with cable 71 wound around spool 22 to achieve the desired control effect. Nine such notches 43 are spaced around the annular raised shoulder 46 (FIGS. 27 and 29) of ring 40 at equally spaced intervals of 40° such that the three projections 33 of housing 30 will always align with three of the notches 43 to provide a significant holding force for the resulting finitely fine adjustment of cable 71 and the element being controlled thereby. In order to adjust cable 70 in the FIG. 3 embodiment, handle 20 is pushed downwardly against the compression of spring 50, disengaging projections or teeth 33 from notches 43, allowing 40° incremental finite adjustment of the cable 71 which winds or unwinds around the spool 22 in groove 25.

If infinite adjustment is desired without the need for ratchet indexing stops, ring 40 is assembled in a reversed position, as shown in FIG. 4, with a smooth surface 45 engaging the tips of projections 33, allowing the handle 20 to be moved smoothly without incremental stops. This configuration typically would be used with the gas-assisted spring of FIG. 1, while the ratchet stop would typically be used with the variable damper of FIG. 2. Although the housing 30 and ring 40 have interengaging projections 33 and slots 43, respectively, these elements can be reversed if desired. Also, different numbers and spacing of these elements can be employed as long as they selectively intermesh to provide a desired control effect.

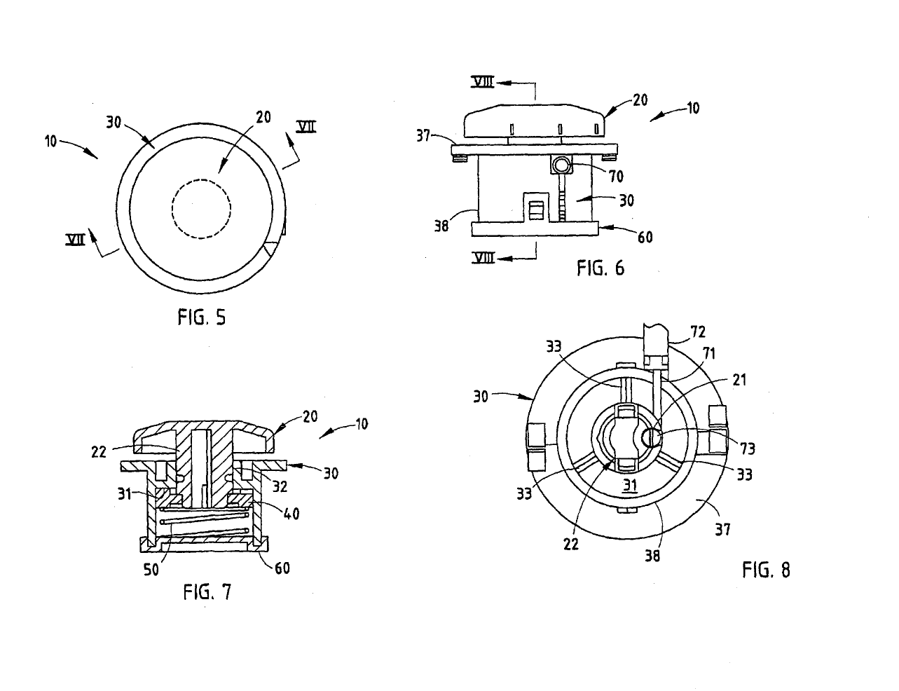

Housing 30 includes a mounting flange 37 (FIGS. 1, 2, 6, 7, 12, and 18-20) at the top of its cylindrical body 38 for mounting within a keyed aperture of, for example, a chair housing. For such purpose also, downwardly depending opposed resilient locking tabs 39 (FIGS. 22 and 26) are provided to lock the actuator 10 to the receiving housing.

The materials used for the integrally molded handle 20 in one embodiment was preferably nylon 6/6 10% glass filled, while the integrally molded housing 30 was made of acetal 30% talc filled in a preferred embodiment. The molded ratchet ring 40 was made of nylon 6/6 10% glass filled, while the molded end cap was acetal 20% talc filled. Spring 50 is a conventional spring steel compression spring with a spring constant K of 5N/mm in one embodiment.

It will become apparent to those skilled in the art that various modifications to the preferred embodiment of the invention as described herein can be made without departing from the spirit or scope of the invention as defined by the appended claims.

The invention claimed is:

1. A rotary actuator for controlling a device utilizing a cable control having an outer sheath and an inner cable comprising:
a housing defining a generally cylindrical opening and including a mounting member for receiving and anchoring the outer sheath of a cable, said housing including an opening for receiving the inner cable therein;
a rotary handle having a spool movably extending downwardly into said cylindrical opening of said housing for rotation with respect to said housing, said spool including a recess for receiving and anchoring an end of the inner cable, said spool further having an end for lockably receiving a ratchet ring;
a ratchet ring having a generally disk-shape extending over and lockably engaging said end of said handle for rotation therewith, said ratchet ring including first and second opposed annular surfaces with said first annular surface including a plurality of one of spaced notches and projections and said second annular surface being generally smooth;
a spring engaging a side of said ratchet ring opposite said handle; and
an end cap engaging a surface of said spring opposite said ratchet ring and coupled to said housing, wherein said housing includes an annular surface facing said ratchet ring and includes the other of projections and notches for selectively interengaging said ratchet ring and holding said handle in predetermined incremental rotational positions under the force of said spring.

2. The actuator as defined in claim 1 wherein said ratchet ring includes a plurality of notches spaced at even intervals thereon.

3. The actuator as defined in claim 2 wherein said annular surface of said housing includes a plurality of radially extending projections spaced at intervals which align said projections with a plurality of said notches.

4. The actuator as defined in claim 3 wherein said notches are spaced at 40° intervals.

5. The actuator as defined in claim 4 wherein said projections are spaced at 120° intervals.

6. The actuator as defined in claim 1 wherein said ratchet ring can be assembled to said spool in reverse orientation to provide engagement of a selected one of said first and second annular surfaces of said ring with said housing.

7. The actuator as defined in claim 6 wherein said ratchet ring includes a central aperture and said spool includes an annular shoulder for engaging a side of an edge of said central aperture of said ratchet ring.

8. The actuator as defined in claim 7 wherein said spool includes resilient locking tabs engaging an opposite edge of said central aperture of said ratchet ring to allow said ratchet ring to be snap-locked to said spool in first or second positions.

9. A rotary actuator for controlling a device utilizing a cable control comprising:
a housing for receiving and anchoring an outer sheath of a cable, said housing including an opening for receiving an inner cable therein, said housing further including a generally cylindrical opening;
a rotary handle having a spool extending downwardly into said cylindrical opening of said housing for rotation with respect to said housing, said spool including a recess for receiving and anchoring an end of the cable; and
a control element extending between said spool and said housing for selectively holding said handle in a predetermined angular relationship to said housing.

10. The rotary actuator as defined in claim 9 wherein said control element comprises a ratchet member on said spool and said housing engages said ratchet member.

11. The rotary actuator as defined in claim 10 wherein said ratchet member is removably attached to said spool in keyed relationship thereto for attachment in one of first and second orientations.

12. The rotary actuator as defined in claim 11 and further including a bias member urging said ratchet member into engagement with said housing.

13. The rotary actuator as defined in claim 11 wherein said ratchet member is ring-shaped and said housing has an annular surface engaged by said ratchet member.

14. The rotary actuator as defined in claim 13 wherein said ratchet member has one of a plurality of spaced notches and projections formed on at least one side thereof and said annular surface of said housing has the other of spaced projections and notches, such that said ratchet member indexes at predetermined positions.

15. The actuator as defined in claim 14 wherein said ratchet member includes a plurality of notches spaced at even intervals thereon.

16. The actuator as defined in claim 15 wherein said annular surface of said housing includes a plurality of radially extending projections spaced at intervals which align said projections with a plurality of said notches.

17. The actuator as defined in claim 16 wherein said notches are spaced at 40° intervals.

18. The actuator as defined in claim 17 wherein said projections are spaced at 120° intervals.

19. A rotary actuator for controlling a device utilizing a cable control having an outer sheath and an inner cable comprising:
a housing defining a generally cylindrical opening;
a rotary handle having a spool movably extending downwardly into said cylindrical opening of said housing for rotation with respect to said housing, said spool including a recess for receiving and anchoring an end of an inner cable, said spool further having a ratchet ring, wherein said ratchet ring has an annular surface with a plurality of one of spaced notches and projections;
a spring engaging a side of said ratchet ring opposite said handle; and
an end cap engaging a surface of said spring opposite said ratchet ring and coupled to said housing, wherein said housing includes an annular surface facing said ratchet ring and including the other of projections and notches for selectively interengaging said annular surface of said ratchet ring for holding said spool in predetermined incremental rotational positions with respect to said housing under the bias force of said spring.

20. The actuator as defined in claim 19 wherein said ratchet ring includes notches spaced at even intervals thereon.

21. The actuator as defined in claim 20 wherein said annular surface of said housing includes a plurality of radially extending projections spaced at intervals which align said projections with a plurality of said notches.

22. The actuator as defined in claim 21 wherein said notches are spaced at 40° intervals.

23. The actuator as defined in claim 22 wherein said projections are spaced at 120° intervals.

24. The actuator as defined in claim 19 wherein said ratchet ring is removably mounted to said spool and can be assembled to said spool in reverse orientation to provide engagement of a selected one of a first and a second annular surface of said ring with said annular surface of said housing.

25. The actuator as defined in claim 24 wherein said ratchet ring includes notches spaced at even intervals thereon.

26. The actuator as defined in claim 25 wherein said annular surface of said housing includes a plurality of radially extending projections spaced at intervals which align said projections with a plurality of said notches.

27. The actuator as defined in claim 26 wherein said notches are spaced at 40° intervals.

28. The actuator as defined in claim 27 wherein said projections are spaced at 120° intervals.
